(19) United States
(12) Patent Application Publication
(10) Pub. No.: US 2009/0076909 A1
(43) Pub. Date: Mar. 19, 2009

(54) VIDEO CHANNEL AD SYSTEM AND METHOD

(76) Inventor: Dimitry Ioffe, Los Angeles, CA (US)

Correspondence Address: PERKINS COIE LLP, P.O. BOX 1208, SEATTLE, WA, 98111-1208, US

(21) Appl. No.: 12/018,130

(22) Filed: Jan. 22, 2008

Related U.S. Application Data
(60) Provisional application No. 60/917,597, filed on May 11, 2007.

(51) Int. Cl. G06Q 30/00; H04N 7/025

(52) U.S. Cl. 705/14; 725/32; 715/719

(57) ABSTRACT

A video channel ad for providing continuous video to a user is described herein. A plurality of thumbnails of various clips may be interacted with to provide various video clips associated with the relevant thumbnails. In maintaining a user's attention, the video plays continuously and transitions between states of the video channel ad are made in a gradual and smooth manner.

### RELATED APPLICATIONS

This Application claims priority to U.S. Provisional Patent Application No. 60/917,597, filed May 11, 2007, and entitled “VIDEO CHANNEL AD SYSTEM AND METHOD” by Dimitry Ioffe, which is incorporated herein by reference.

### BACKGROUND

A user with a web browser connected to the internet can receive a website having advertising material. The use of video with a website is known in the art as providing a valuable experience to a user. Video engages a user in the subject matter of, e.g. a motion picture, more closely than mere graphics with text or even graphics with sound and text.

In advertising a video, a clip of a video can be provided to a user. This clip includes stimulating material which engages a user in a specific portion of the video. This entices the user to want to see more of the video, thus encouraging the user to view more of the video and eventually pay to view the whole video. Increasingly, more than one clip of a video is used to provide different engaging aspects of a video to form an interest in the video in the user's mind.

As technology and the speed of life have increased, delays of any kind which interrupt a user's experience have become more and more noticeable. This sensitivity to disruption has made users skiddish, causing them to navigate away from websites which bring them delay. Once a user has navigated away from a website, the opportunity to form an interest in the products or services is lost.

The foregoing examples of the related art and limitations related therewith are intended to be illustrative and not exclusive. Other limitations of the related art will become apparent to those of skill in the art upon a reading of the specification and a study of the drawings.

### SUMMARY

The following embodiments and aspects thereof are described and illustrated in conjunction with systems, tools, and methods that are meant to be exemplary and illustrative, not limiting in scope. In various embodiments, one or more of the above described problems have been reduced or eliminated, while other embodiments are directed to other improvements.

It is advantageous to provide video to a user. Further it is advantageous to provide that video in a continuous manner. This uninterrupted video maintains the user's experience providing the opportunity to develop interest in a video.

A web browser including a video channel ad is provided. The video channel ad receives an interaction and expands in a gradual and smooth manner continuously providing video. A plurality of thumbnails of relevant videos is provided as well as a number of buttons for controlling features of the video channel ad. A user interacting with the video channel ad may interact using any device that can input interactions, which would include, but not be limited to a keyboard and mouse.

When interacting with the video channel ad, features include choosing videos to play, increasing and decreasing sound volume, providing text and images relevant to the video, as well as increasing and decreasing the size of the video.

Other features which provide related content to the user are contemplated. Examples of such other features include “story,” “downloads,” “quiz,” “send to a friend,” and “shrink video.” However, the specific features are provided by way of example only; it is understood that a variety of features could be provided.

### BRIEF DESCRIPTION OF THE DRAWINGS

Embodiments of the inventions are illustrated in the figures. However, the embodiments and figures are illustrative rather than limiting; they provide examples of the inventions.

FIG. 1 depicts a video channel ad for continuously playing video having a plurality of thumbnails for choosing video to display as well as buttons to enable related features.

FIG. 2 depicts a flowchart for providing video using a video channel ad.

FIG. 3 depicts a video channel ad expanding in response to an interaction.

FIG. 4 depicts a video channel ad changing a video to play in response to an interaction.

FIG. 5 depicts a video channel ad decreasing the size of the video playing in the video channel ad and displaying text relevant to the video playing in the remaining portion of the video channel ad.

FIG. 6 depicts a user interacting with a video channel ad via a computer.

FIG. 7 depicts an information management system transmitting a video channel ad to a computer for a user to interact with.

FIG. 8 is a screenshot of an unexpanded video channel ad.

FIG. 9 is a screenshot of a video channel ad in an intermittent state between unexpanded and expanded as the video channel ad is expanding.

### DETAILED DESCRIPTION

In the following description, several specific details are presented to provide a thorough understanding of embodiments of the invention. One skilled in the relevant art will recognize, however, that the invention can be practiced without one or more of the specific details, or in combination with other components, etc. In other instances, well-known implementations or operations are not shown or described in detail to avoid obscuring aspects of various embodiments of the invention.

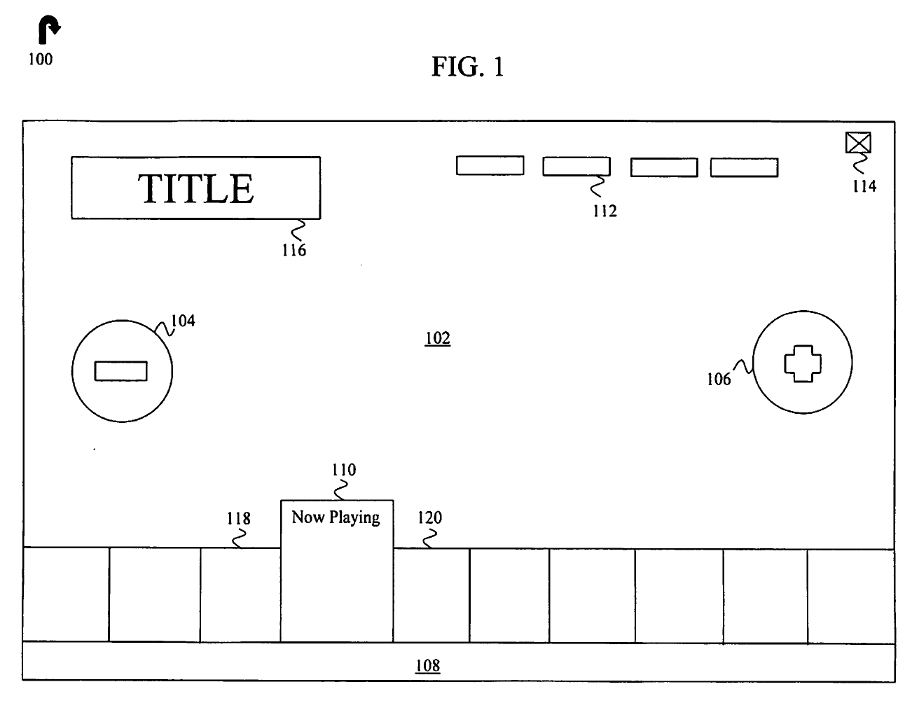

FIG. 1 depicts a video channel ad 100. Video channel ad 100 includes video 102, first video selection button 104, second video selection button 106, plurality of thumbnails 108, activated thumbnail 110, function button 112, and exit button 114, title 116, previous video thumbnail 118, subsequent video thumbnail 120.

In the example of FIG. 1, video 102 plays continuously in video channel ad 100. Title 116 is displayed as a non-video graphic covering part of the video including e.g. the name of the video. Plurality of thumbnails 108 run near an edge of the video, and upon interaction with activated thumbnail 110, video 102 plays video correlated with thumbnail 110. Upon interaction first video selection button 104 the video 102 change to a previous video associated with the previous video thumbnail 118. Upon interaction with the second video selection button 106, the video 102 changes to a subsequent video associated with the subsequent video thumbnail 120.

In the example of FIG. 1 function button 112 provides one of a number of different features which when interacted with causes the video channel ad to display relevant information. E.g. if the function button 112 is a “story” button, the video 102 will decrease in size, and text explaining the story of the video 102 will be displayed. Function button 112 may or may not be selected from the following group of buttons “story,” “downloads,” “quiz,” “send to a friend,” and “shrink video” other functions are contemplated. Interaction with the exit button 114 may cause the video channel ad to cease to play video and to decrease in size.

In the example of FIG. 1, interaction may include, but is not limited to rolling over, clicking, right clicking, left clicking, third mouse button clicking, wheel mouse button clicking, wheel mouse scrolling, and keyboard key depress.

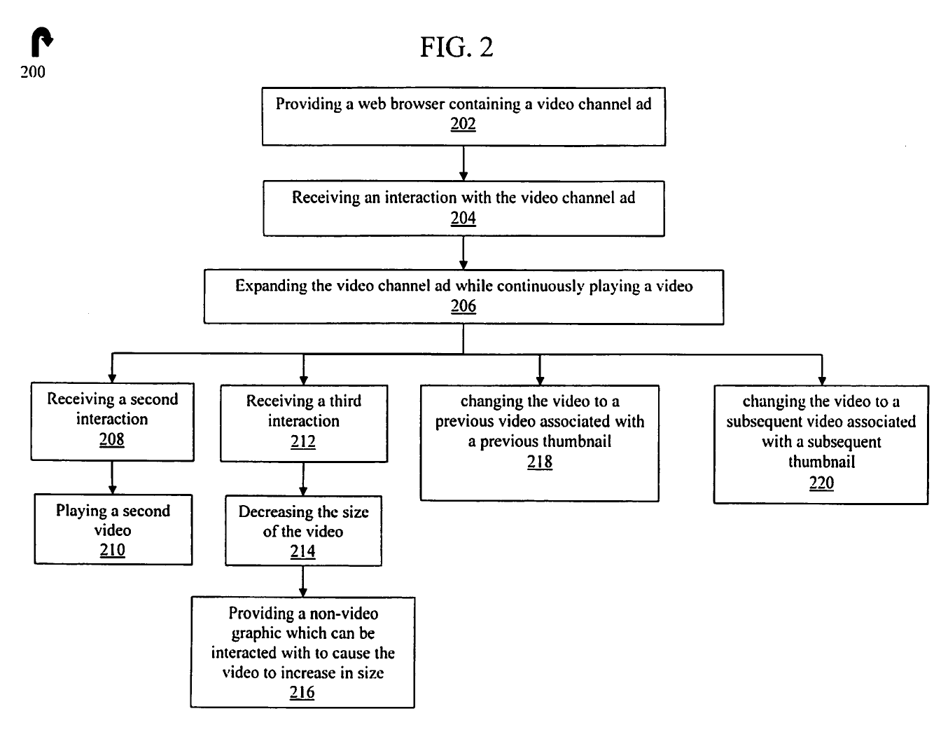

FIG. 2 depicts a flowchart 200 as an example of a method for providing video. The method is organized as a sequence of modules in the flowchart 200. However, it should be understood that these and modules associated with other methods described herein may be reordered for parallel execution or into different sequences of modules. In the example of FIG. 2, the flowchart starts at module 202 with providing a web browser including a video channel ad. This web browser can be any device for interacting with a video channel ad, and would extend to integrated systems, web TV devices, and other methods of accessing a web page.

In the example of FIG. 2, the flowchart 200 continues to module 204 where an interaction with the video channel ad is received. The video channel ad responds to the interaction in module 206 by expanding while continuously playing video. In expanding, portions of the video may or may not be visible until the video channel ad is fully expanded. Any portions of the video not displayed may be clipped and the remaining portion of the video displayed. In proceeding from module 206, flowchart 200 may proceed to module 208, module 212, module 218, or module 220.

In the example of FIG. 2, flowchart 200 may proceed from module 206 to module 208 where a second interaction is received. A user may interact with a number of different parts of the video channel ad such as the buttons, the thumbnails, or the volume controls. Here, the user has interacted with one of the plurality of thumbnails, or graphics identifying additional videos, to select a video to play in the video channel ad. The flowchart then proceeds to module 210 where video channel ad then plays the video associated with the thumbnail that the user has selected.

In the example of FIG. 2, the flowchart 200 may alternatively proceed from module 206 to module 212 where the video channel ad receives a third interaction. A function button may be interacted with, e.g. the “shrink video” button. Where the “shrink video” button has been interacted with, flowchart 200 proceeds to module 214 where the size of the video is decreased. From this point, flowchart 200 may proceed to module 216, where a non-video graphic, e.g. a “big video” button is displayed, which when interacted with will increase the size of the video.

In the example of FIG. 2, the flow chart may alternatively proceed from module 206 to module 218 or module 220 with changing the video to a previous video associated with a previous thumbnail. Module 218 is directed to a non-video graphic which can be interacted with to change the video to a previous video. In the case of module 218, an interaction will result in the previous thumbnail becoming an activated thumbnail, and a video associated with the previous thumbnail playing. In module 220 a non-video graphic may be interacted with to change the video to a subsequent video associated with a subsequent thumbnail. The subsequent thumbnail may be activated, and the video associated with the subsequent video may begin to play.

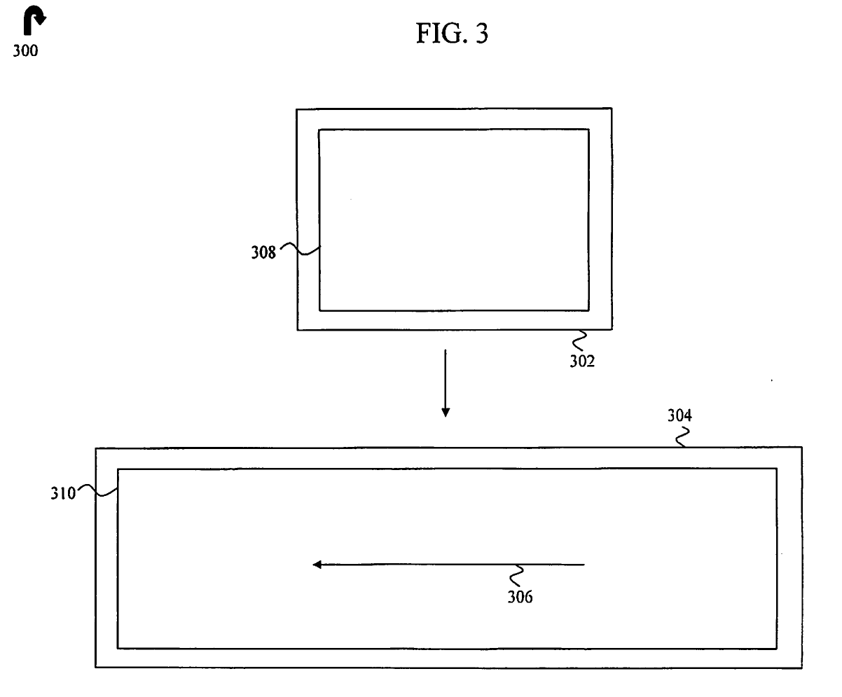

FIG. 3 depicts an expanding video channel ad 300. Expanding video channel ad 300 includes unexpanded video channel ad 302, expanded video channel ad 304, direction of expansion 306, partial video 308, and full video 310.

In the example of FIG. 3 an interaction with unexpanded video channel ad 300 results in the expansion of unexpanded video channel ad 302 in a direction of expansion 306. It should be noted that the direction of expansion could be any of up, down, left, right, any direction diagonally, or more than one direction at the same time such as an expanding square, circle etc. In the example of FIG. 3 direction of expansion 306 is leftward. Partial video 308 plays in unexpanded video channel 302, and plays continuously as unexpanded video channel 302 expands to become expanded video channel 304. At the points which the expanding video channel ad is between unexpanded video channel ad 302 and expanded video channel ad 304 the video plays continuously as the video channel ad expands gradually and in a smooth transition.

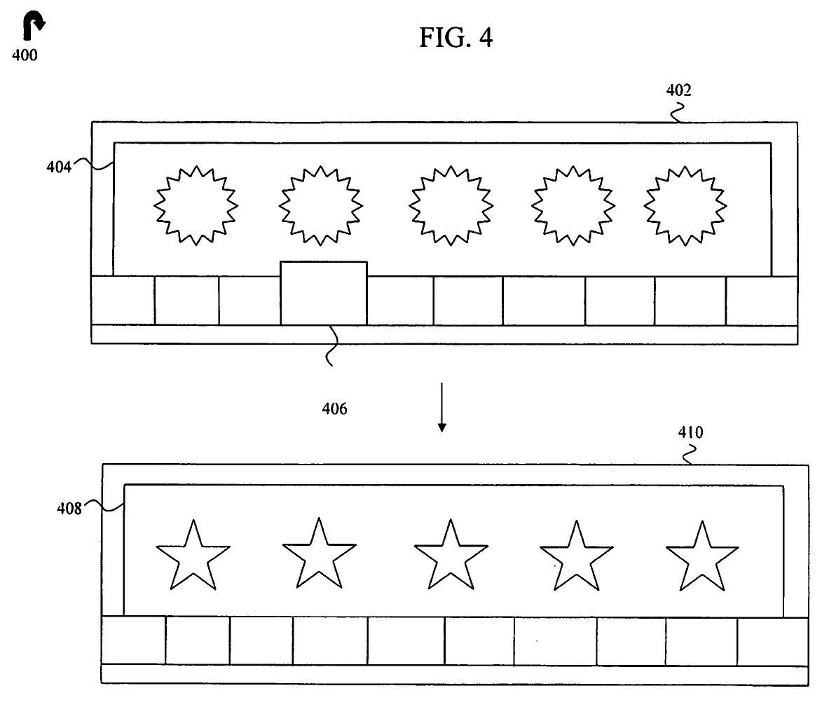

FIG. 4 depicts a video channel ad 400 changing a video in response to an interaction with a thumbnail. Video channel ad 400 includes first stage 402, first video 404, thumbnail 406, second video 408, and second stage 410. In the example of FIG. 4, the first stage 402 is a fully expanded video channel ad displaying first video 404. Then a user interacts with thumbnail 406, and the video channel ad enters second stage 410 playing second video 408.

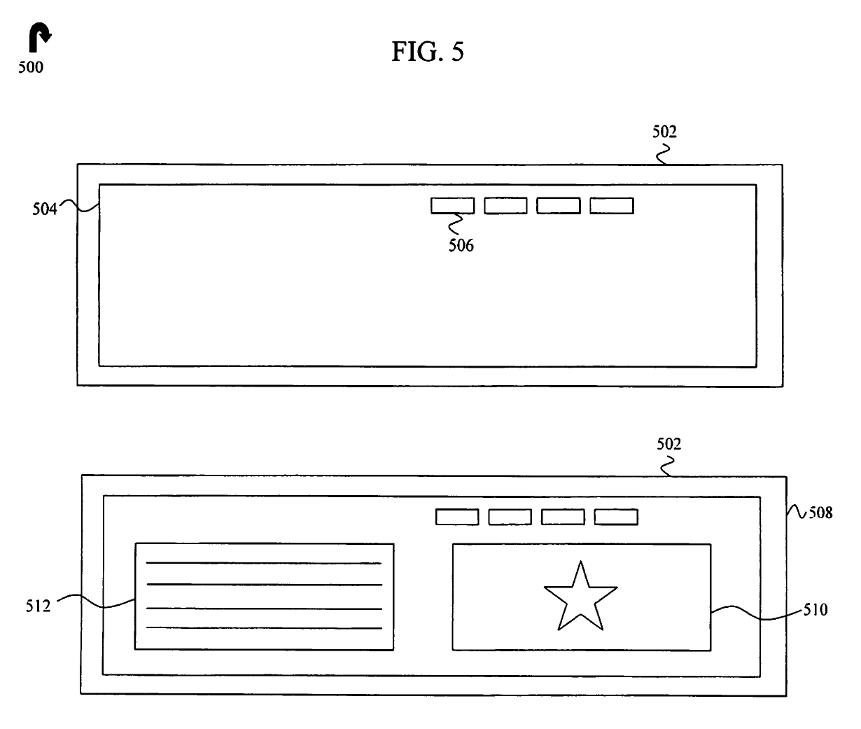

FIG. 5 depicts a video channel ad 500 decreasing the size of the video playing in the video channel ad and displaying text relevant to the video playing in the remaining portion of the video channel ad. Video channel ad 500 includes first stage 502, video 504, function button 506, second stage 508, video 510, and text 512.

In the example of FIG. 5 first stage 502 of a video channel ad displays video 504 and function button 506. Upon an interaction with function button 506 video channel ad 500 becomes second stage 508. The video 504 is shrunken to video 510. During this process the user is provided with the experience of continuous video. The transition may or may not involve the use of a single frame of a video during the transition which is shrunken as the transition occurs.

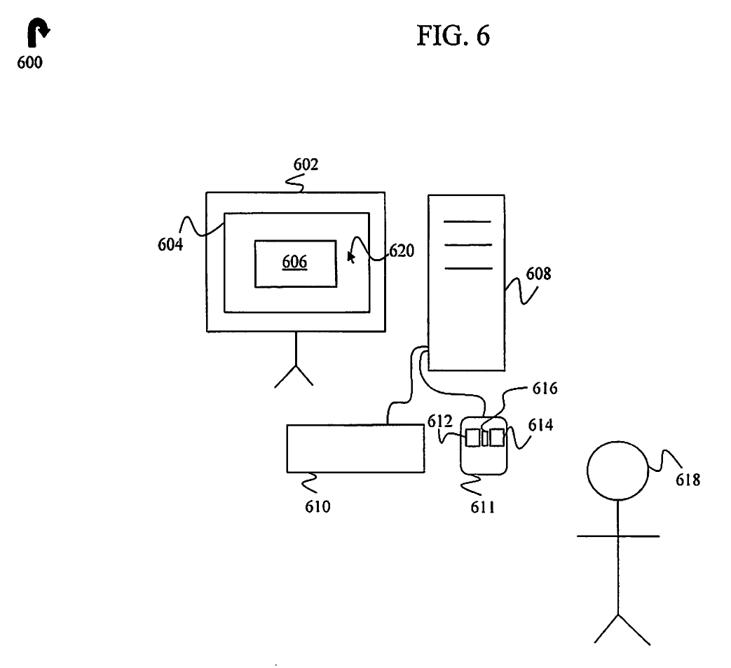

FIG. 6 depicts an example of a system 600 for interacting with a website: a computer with a keyboard and mouse. The system 600 includes a monitor 602, a web browser 604, a video channel ad 606, a computer 608, a keyboard 610, a mouse 611, a first button 612, a second button 614, a third button 616, a user 618, and a pointer 620.

In the example of FIG. 6, the user views monitor 602. Displayed on monitor 602, the user views the ported website 606 as covering over the website 604. The user interacts with the video channel ad 606 via input devices such as keyboard 610 and mouse 612. These interactions include rolling over, clicking, right clicking, left clicking, third mouse button clicking, wheel mouse button clicking, wheel mouse scrolling, and keyboard key depress. It is understood that there are other ways of interacting with a computer, and that one skilled in the art would implement a viable alternative to a keyboard and mouse in keeping with the spirit of these teachings.

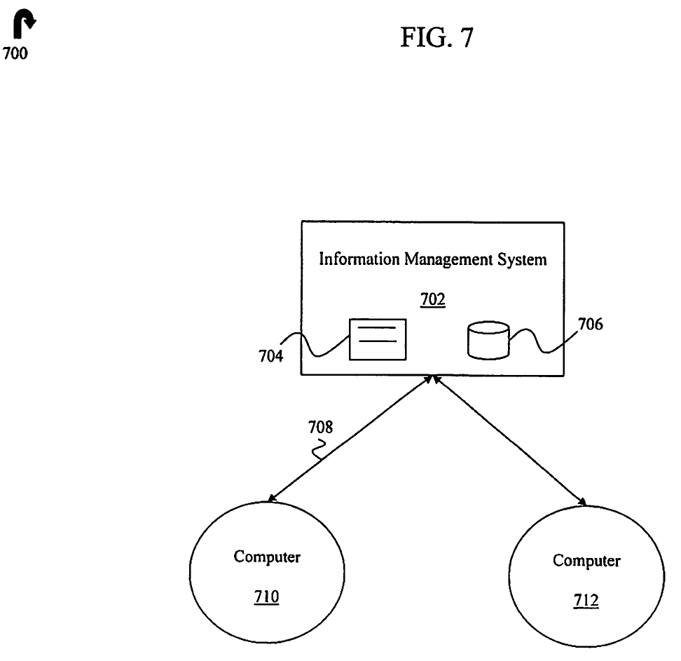

FIG. 7 depicts an example of a system 700 providing a video channel ad to a user. System 700 includes information management system 702, server 704, database 706, network 708, computer 710, and computer 712. In the example of FIG. 7, information management system 702 provides a website including a video channel ad to computer 710 via network 708. Server 704 transmits the video channel ad. Data relevant to the video channel ad may or may not be stored in database 706.

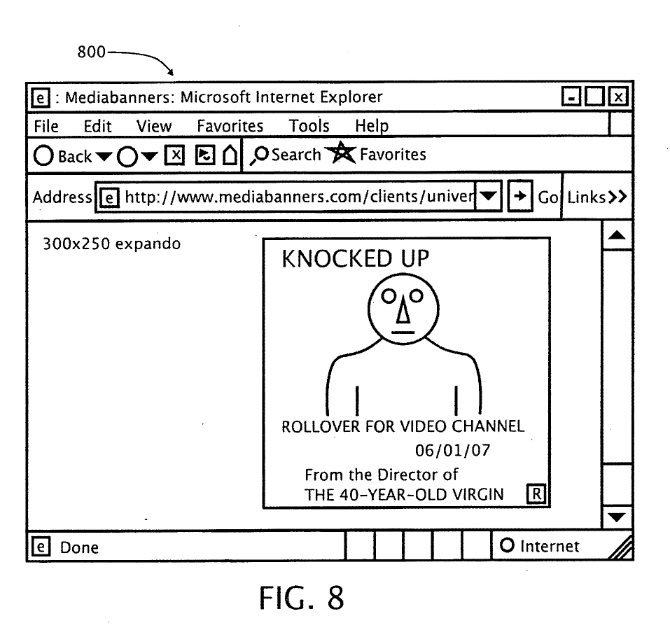

FIG. 8 is a screenshot of an unexpanded video channel ad. The screenshot depicts the unexpanded video channel ad presenting the motion picture “Knocked Up.”

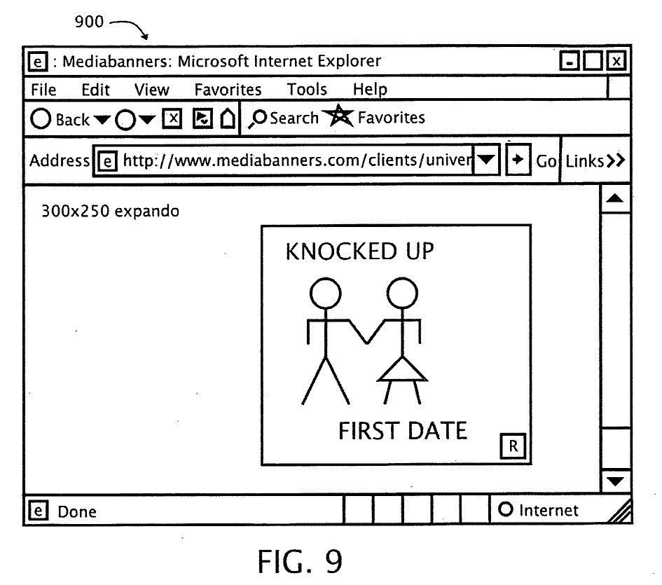

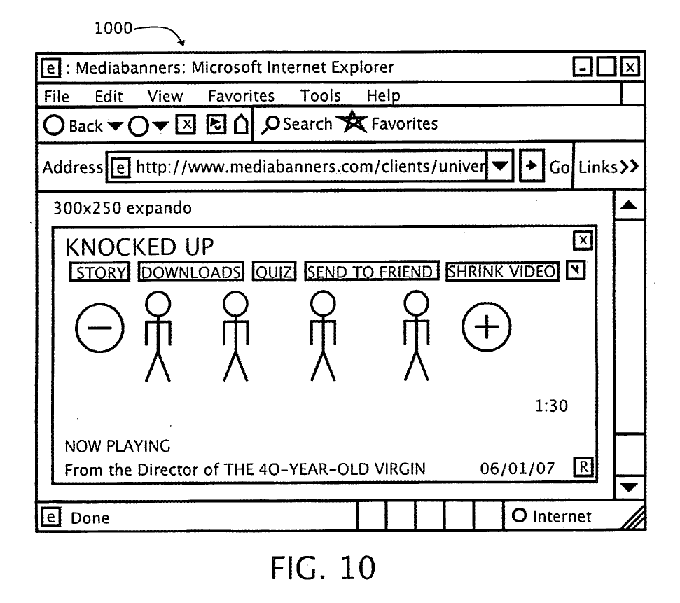

FIG. 9 is a screenshot of a video channel ad in an intermittent state between unexpanded and expanded as the video channel ad is expanding. The screenshot includes a partially clipped frame from a continuously provided video of a scene in the motion picture “Knocked Up.” The amount of clipping is based on the intermittent stage of the video channel ad.

FIG. 10 is a screenshot of an expanded video channel ad. The expanded video channel ad plays continuous video from a scene in the motion picture “Knocked Up.” The video is not clipped by the expanding video channel ad as the screenshot is of a full expanded video channel ad.

It will be appreciated to those skilled in the art that the preceding examples and embodiments are exemplary and not limiting to the scope of the present invention. It is intended that all permutations, enhancements, equivalents, and improvements thereto that are apparent to those skilled in the art upon a reading of the specification and a study of the drawings are included within the true spirit and scope of the present invention. It is therefore intended that the following appended claims include all such modification, permutations and equivalents as fall within the true spirit and scope of the present invention.

We claim:

1. A method of providing video comprising:
providing a web browser including a video channel ad;
receiving an interaction with the video channel ad;
expanding the video channel ad, gradually in a smooth manner,
maintaining the video channel ad in an original position, the video channel ad displaying a plurality of thumbnails for choosing video to display, the video channel ad continuously playing a video, wherein selecting a thumbnail invokes a related video to play in the video channel ad.

2. The method of claim 1 wherein a second interaction with a thumbnail of the plurality of thumbnails causes a second video to play.

3. The method of claim 1 wherein the video plays in the video channel ad prior to expanding the video channel ad.

4. The method of claim 1 wherein the video plays in the video channel ad subsequent to expanding the video channel ad.

5. The method of claim 1 further comprising:
decreasing the size of the video playing in the video channel ad in response to a third user interaction with a button.

6. The method of claim 5 further comprising:
providing a non-video graphic which can be interacted with to cause the video to increase in size.

7. The method of claim 1 further comprising:
providing a non-video graphic which can be interacted with to change the video to play a previous video associated with a previous thumbnail.

8. The method of claim 1 further comprising:
providing a non-video graphic which can be interacted with to change the video to play a subsequent video associated with a subsequent thumbnail.

9. The method of claim 1 wherein the video channel ad has a non-video graphic covering portions of the video.

10. The method of claim 1 further comprising:
displaying text in the video channel ad relevant to the video playing in the video channel ad.

11. The method of claim 1 wherein the interaction is selected from the group consisting of rolling over, clicking, right clicking, left clicking, third mouse button clicking, wheel mouse button clicking, wheel mouse scrolling, and keyboard key depress.

12. A system for providing a video channel ad comprising:
a web browser including a video channel ad having a plurality of thumbnails for selecting video to play;
a computer running the web browser having a monitor displaying the video channel ad;
a user input device connected to the computer;
a user interacting with the video channel ad via the input device causing the video channel ad to expand the video channel ad, gradually in a smooth manner maintaining the video channel ad in an original position.

13. The system of claim 12 wherein a video plays in the video channel ad prior to expanding the video channel ad.

14. The system of claim 12 wherein a video plays in the video channel ad subsequent to expanding the video channel ad.

15. The system of claim 14 further comprising:
a second video in the video channel ad, the second video plays in response to a second user interaction with a thumbnail of the plurality of thumbnails.

16. The system of claim 12 wherein the video channel ad further comprises:
a non-video graphic which can be interacted with by the user to change the video to a subsequent video associated with a subsequent thumbnail.

17. The system of claim 12 wherein the video channel ad further comprises:
a non-video graphic which can be interacted with to cause the video to decrease in size.

18. The system of claim 12 wherein the video channel ad further comprises:
a non-video graphic which can be interacted with to cause the video to increase in size.

19. The system of claim 12 further comprising:
a non-video graphic covering a portion of the video.

20. The system of claim 12 further comprising:
displaying text in the video channel ad relevant to the video playing, the user views the text.

21. The system of claim 12 wherein the interaction is selected from the group consisting of rolling over, clicking, right clicking, left clicking, third mouse button clicking, wheel mouse button clicking, wheel mouse scrolling, and keyboard key depress.

22. The system of claim 12 further comprising:
an information management system transmitting the video channel ad to the computer via a network.

23. A video channel ad embodied in a computer readable medium comprising:
a video having sound;
a plurality of thumbnails, each of which when interacted with cause the video to change to a new video;
a subsequent video selection control which causes the video to play a subsequent video;
a previous video selection control which causes the video to play a previous video;
a plurality of function buttons causing the video channel ad to display content.

24. The video channel ad embodied in a computer readable medium of claim 23 wherein one of the plurality of function buttons is selected from the group consisting of (“story,” “downloads,” “quiz,” “send to a friend,” and “shrink video”).

25. The video channel ad in a computer readable medium of claim 23 further comprising an exit button which when interacted with reduces the video channel ad in size and causes the video to cease.
